(19) United States
(12) Patent Application Publication
(10) Pub. No.: US 2006/0015498 A1
(43) Pub. Date: Jan. 19, 2006

(54) Search engine

(76) Inventors: Edgar Sarmiento, New Britain, CT (US); Dan Li, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 11/201,884

(22) Filed: Aug. 11, 2005

Related U.S. Application Data
(60) Provisional application No. 60/601,736, filed on Aug. 13, 2004.

(51) Int. Cl. G06F 17/30

(52) U.S. Cl. 707/6

(57) ABSTRACT

One aspect of the present disclosure is directed to a system and method for characterizing a user comprising obtaining a user's personal information, making inferences about personal characteristics, and one or more of the following: obtaining bookmarks from the user and calculating bookmark scores. Another aspect of the present disclosure is directed to a system and method for ordering websites retrieved from a database for a characterized query_issuer, comprising: calculating a fitness value for each website in the database based on the personal characteristics of the query_issuer and bookmark_creators; and ranking the search results based on the fitness value (which we call “Personal Distance”). Another aspect of the present disclosure is directed to a system and method for classifying keywords of a search into subcategories, comprising: obtaining a search subject; and obtaining a search purpose. Because of the rules governing abstracts, this abstracts should not be used to construe the claims

### CROSS-REFERENCE TO RELATED APPLICATIONS

None.

### STATEMENT REGARDING FEDERALLY SPONSORED RESEARCH

Not applicable.

### BACKGROUND OF THE INVENTION

The present invention is directed to a search engine of the type that can be used for searching the World Wide Web.

We are living in an era where information is swamping our lives. The information over-supply is a problem because some of the information is good, but other information is useless, irrelevant, and perhaps even harmful. The cost of “bad information” is not only loss of time, but bad information can also lead to misjudgment, mistakes and a loss of otherwise good opportunities. If we call information with high relevance and accuracy “good information” and those opposite “noise”, then the noise/information ratio as time passes is drastically growing larger.

We need a tool to help us filter out the noise. Search engines are such a tool. Search engines significantly enhance our access to otherwise unlimited information. But obtaining the most relevant and “good quality” information is still an open problem. Both the relevance and quality factors are highly subjective. Relevance and quality can be significantly different to different people depending on their search purpose, occupation, gender, age, and other personal factors.

### BRIEF SUMMARY OF THE INVENTION

This disclosure is directed to a system and method to retrieve information from a database, such as the World Wide Web. In this disclosure, we introduce two concepts. “Personal Distance” is a metric used to improve search results based on the recognition that similar individuals should have similar preferences for items in the database. The first concept filters information by using a unique algorithm that takes into account: personal characteristics of the user, bookmarks of the user, personal characteristics of similar users, and bookmarks of similar users. The second concept is “Search Subject”. “Search Subject” is a recognition that search results will be improved if you separate a search subject from the overall search. A unique algorithm is used to distinctly separate and use the search subject. These two concepts are independent of one another, and either or both may be used to improve searching.

The system and method of the present disclosure begins by characterizing each user by: obtaining a user's personal information (e.g. occupation, age, sex) and making inferences on personal characteristics, which we will identify as Xs; obtaining bookmarks from the user, where bookmark is a term referring to a data point or website classified by the user as valuable enough to return to at a later point in time; and calculating bookmark scores, which are quality ratings of the data points/websites, which we will identify as Bs. This process is applied to many individuals, resulting in a database of bookmarks and bookmark_creators, which we will identify as Ys.

The method of the present disclosure further includes: obtaining from the user a query to search the Internet or some other database. A traditional search by keyword or other method may be performed and a number of relevant data points/websites returned. The relevant data points/websites are then matched with an existing database of bookmarks (which was described in the earlier paragraph). If a match exists, the personal characteristics of the query_issuer are compared to the personal characteristics of all individuals who have included the data point/website as a bookmark.

The above can be written as P, a fitness value for each data point/website, which is a function (D and B), where D is Personal Distance. D=[Query_issuer (w₁X₁,w₂X₂, w₁Xₙ)−Bookmark_creators (w′₁Y₁,w′₂Y₂, w′ₙYₙ)]. B, as mentioned above, is the quality rating of the data point/website that will be calculated from any explicit score from individuals. High quality rated bookmarks increase the fitness value, while low quality rated bookmarks decrease the fitness value. Search results are ranked and presented to the query_issuer based on P.

The quality of the search results are confirmed with the user. Based on the user's confirmation, the weights are recalculated, resulting in dynamic learning. With each confirmed search result, dominant personal characteristics will be learned and given more weight in future searches. The bookmark scores will also be updated with each confirmed search result, which will further improve the fitness value.

Another aspect of the present invention is a system and method to perform a search by classifying keywords into distinct sub-categories. K is the sub-categories. It may consist of two factors, search subject and search purpose. The ability to classify search subject and search purpose can be accomplished with the use of multiple input boxes. The traditional use of only one input box burdens the search algorithm to “read the mind” of the query_issuer. In using sub-categories, keywords associated with the search subject are ranked higher than the keywords associated with the search purpose. Correspondingly, search results would return data points/websites more closely related to the search subject. This is a new concept, as opposed to traditional keyword searches where keywords are treated equally and/or in the order typed-in.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 is a flow chart of a characterization module for determining personnel characteristics X.

FIG. 1A is an example of a welcome screen.

FIG. 1B is an example of a new members screen.

FIG. 1C is an example of a personalization screen.

FIG. 2 is a flow chart of a characterization module for determining bookmarks B.

FIG. 2A is an example of a bookmark screen.

FIG. 3 is a flow chart of a characterization module for determining a network of friends.

FIG. 3A is an example of an invite friends screen.

FIG. 4 is an exemplary screen for inputting information into a search engine.

FIG. 4A is an example of an input/output screen.

FIG. 5 is a flow chart illustrating how search results may be evaluated by a computation engine.

FIG. 6 is a flow chart illustrating the output of search results and the confirmation and dynamic learning aspects of the present invention.

FIG. 7 illustrates a system on which the methods of the present invention can be practiced.

### DETAILED DESCRIPTION OF THE INVENTION

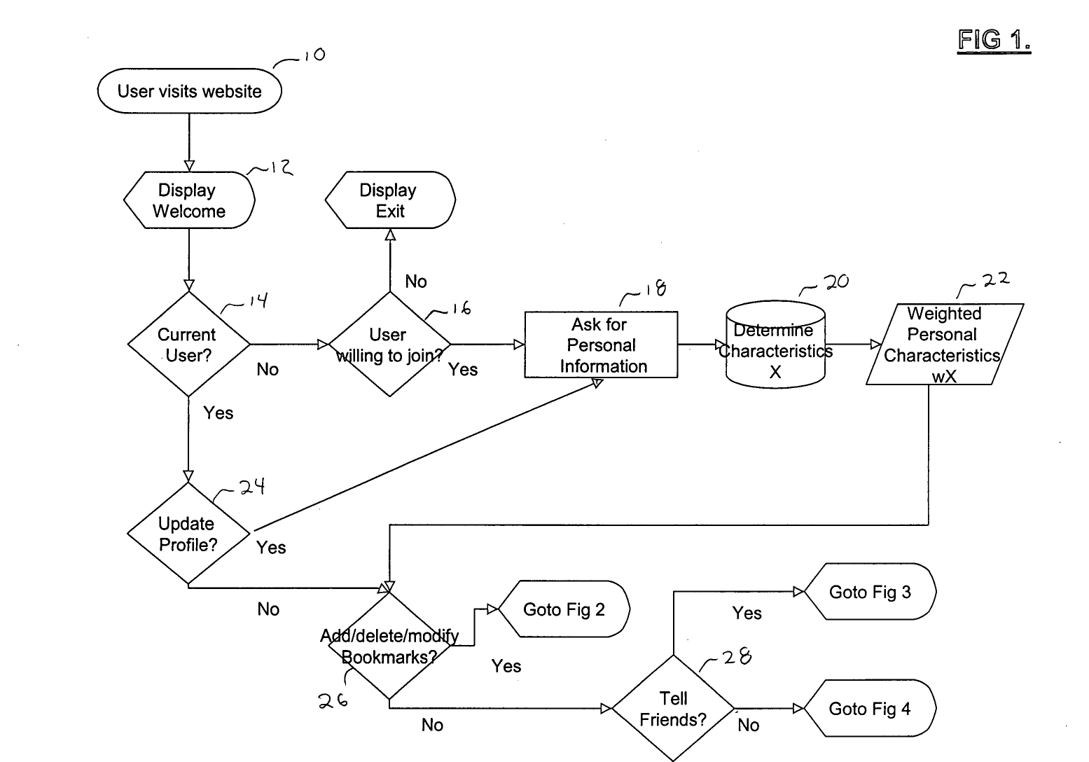

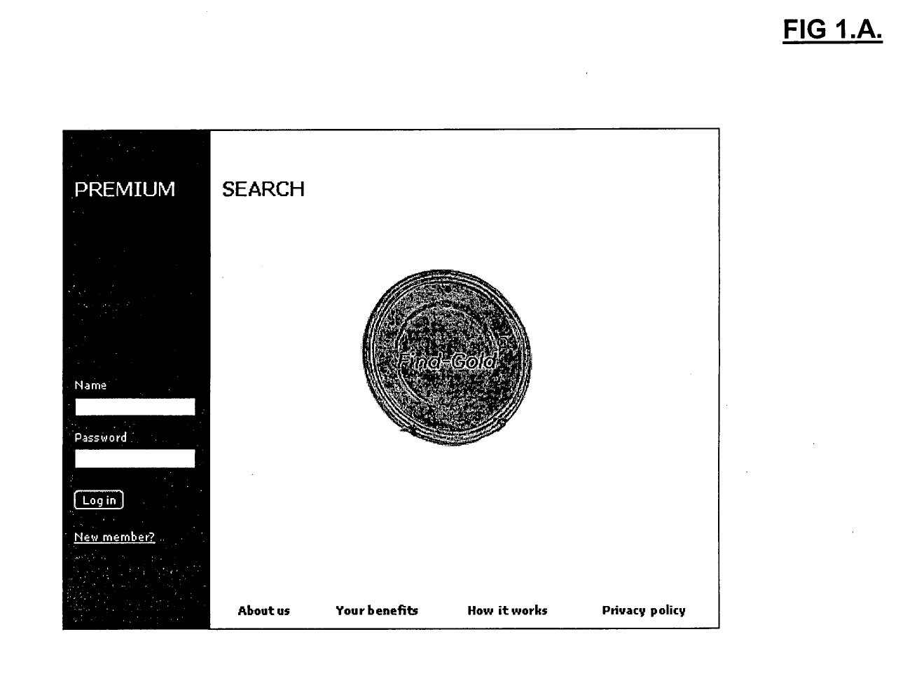

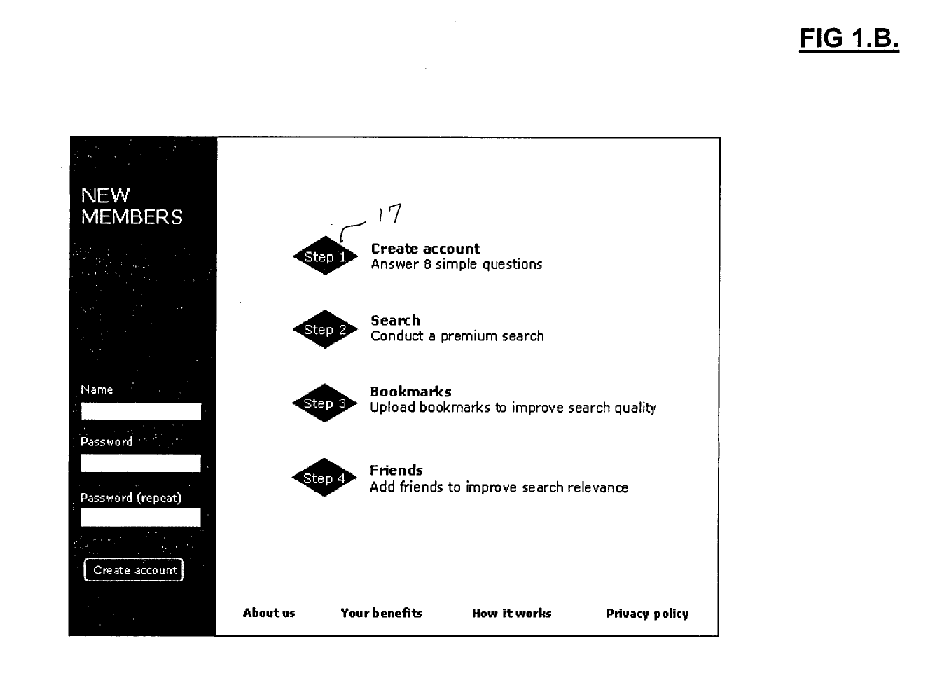

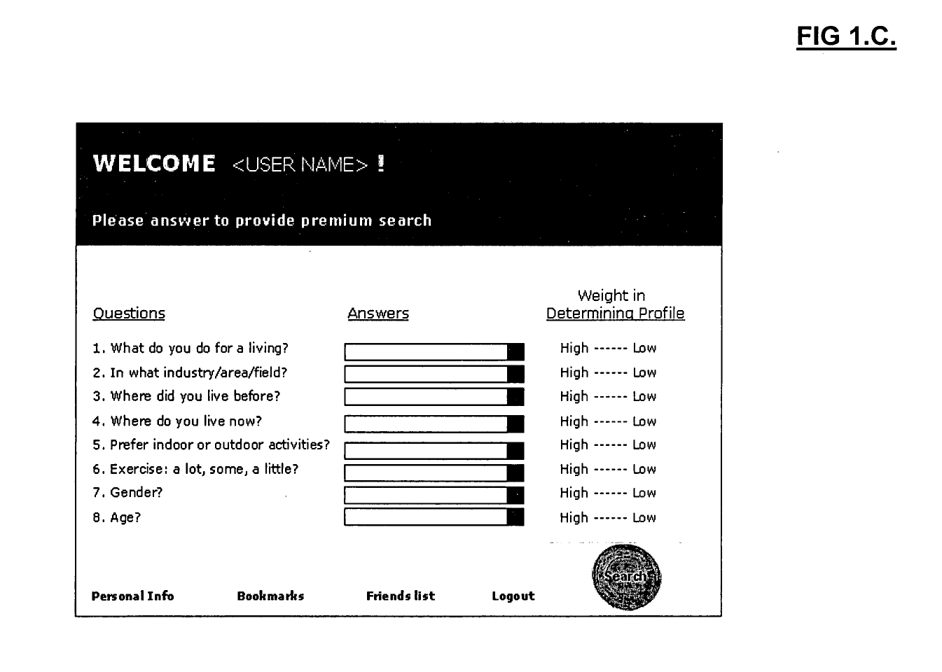

In FIG. 1, users may sign-on at 10 and be shown a welcome screen, of the type shown in FIG. 1A, at 12 in the process flow shown in FIG. 1. If the user is not a current user, as determined by 14, the user will be asked at 16 if they are willing to join by, for example, displaying a new member screen of the type shown in FIG. 1B. If, at the screen shown in FIG. 1B, the user is willing to become a member, the user is may create an account clicking on the “step 1” icon as shown by the reference number 17. Process flow continues with 18, FIG. 1, in which personal information is solicited. The information may be gathered using a screen of the type shown in FIG. 1C.

A direct approach is used to achieve maximum accuracy while asking only a few questions to minimize demands on the users. We request personal, but not insidious information by asking basic questions such as, “What do you do for a living? What industry? Where do you live? Gender? Age?, etc. In addition, as much control as possible is given to the user. Users can create multiple profiles and add/delete/modify their profiles. Then, inferences are made at 20 in FIG. 1 based on the supplied information to determine the user's personal characteristics X and assign values related to its strength. The values are then given weights at 22. The following are ten examples of personal characteristics:
Function Characteristic—what the user does for a living, i.e. Banker
Industry Characteristic—what is the user's area/field of expertise, i.e. Health Sector
Geographic Characteristic—where the user lives, i.e. Pittsburgh, Pa.
Origin Characteristic—where the user grew up, i.e. San Francisco, Calif.
Gender Characteristic—the user's gender, i.e. Male
Wealth Characteristic—the user's estimated price point f(Function, Industry, Geographic, Age)=a number from 1-100.
Innovative Characteristic—the user's preference towards new ideas. f(Diff(Geographic-Origin), Age, Function)=a number from 1-100.
Health Characteristic—the user's preference towards health issues f(Outdoor activities, Exercise a lot, Age)=a number from 1-100.
Time Value Characteristic—how much the user values time f(Wealth, Geographic, Exercise a little)=a number from 1-1 00.
Risk Taker Characteristic—preference of false positives over false negatives f(Diff(Geographic-Origin), Outdoor activities, Exercise a lot, Age,)=a number from 1-100.

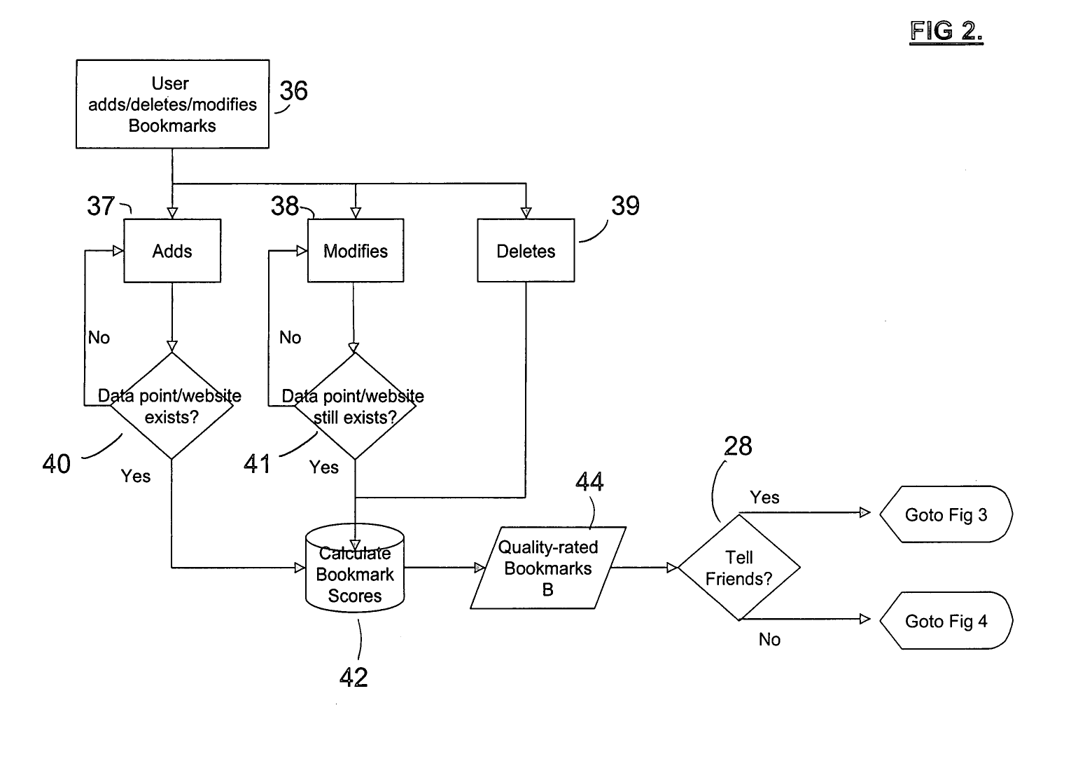

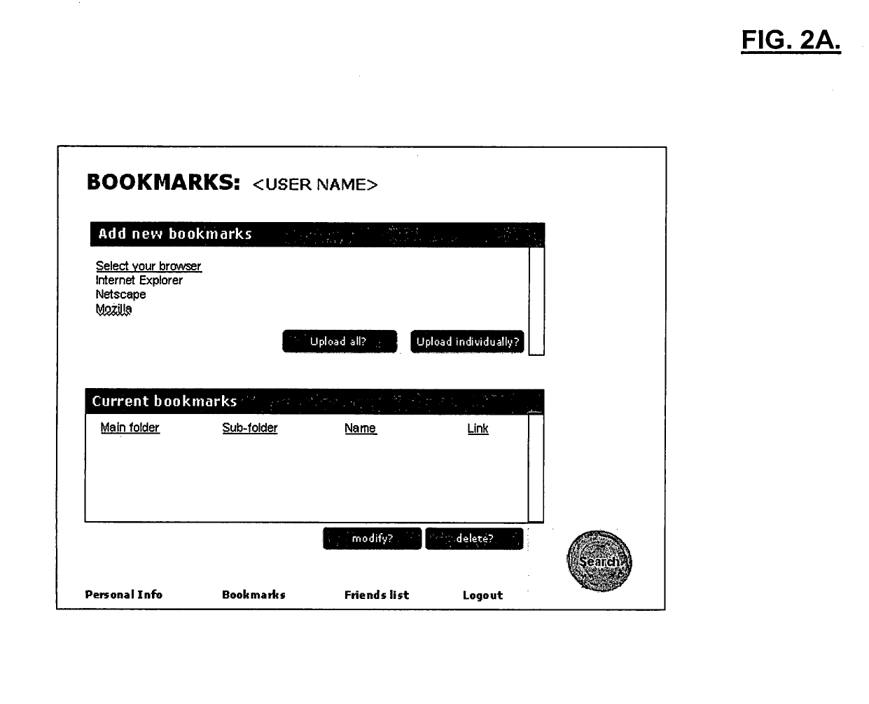

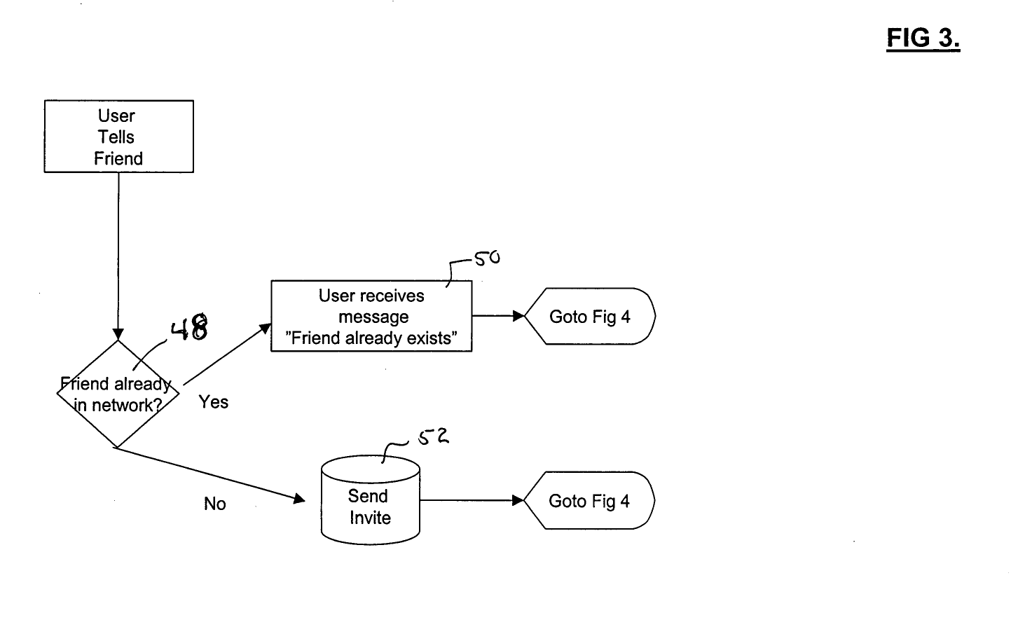

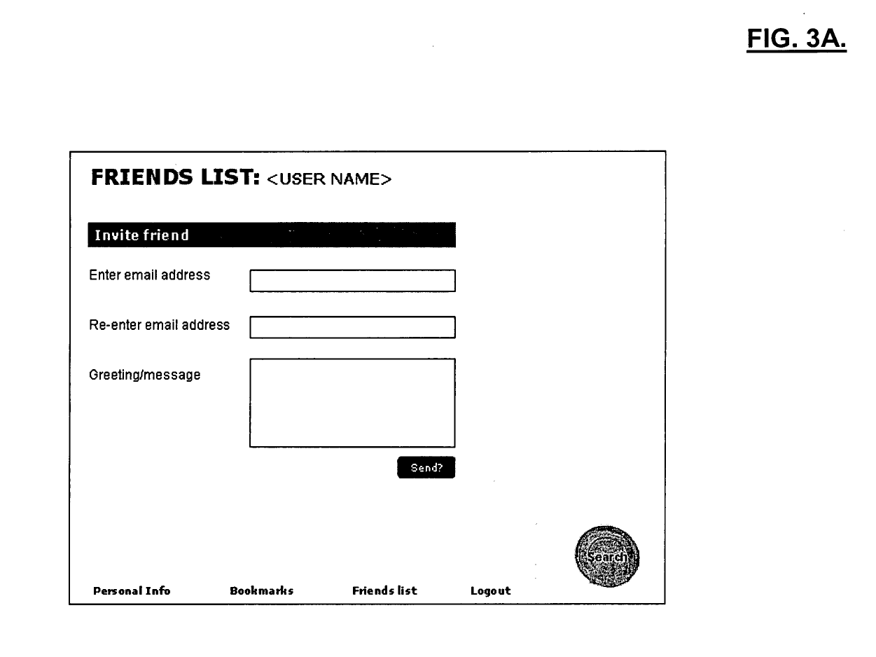

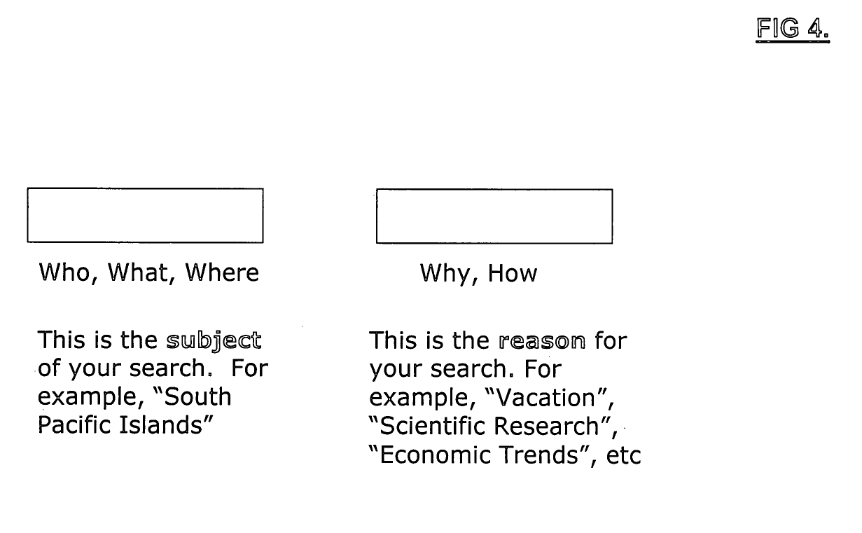

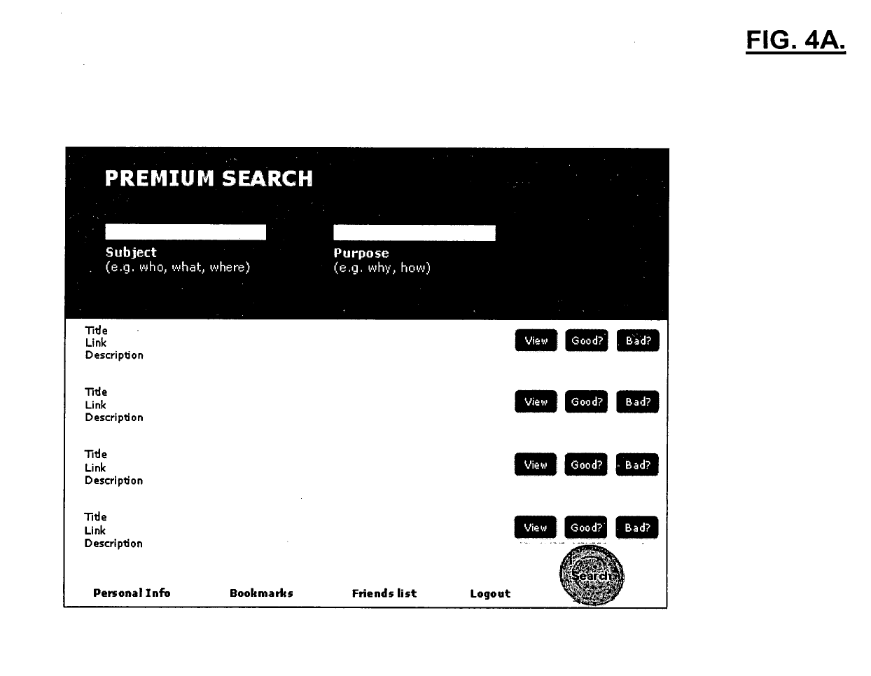

If, at 14, the user is a current user, the user is asked if they wish to update their profile at 24. If the answer if “yes”, process flow continues with 18. If the answer is “no”, the user is given an opportunity to add, delete, or modify bookmarks at 26. If the answer at 26 is “yes”, process flow continues with FIG. 2. If the answer is “no”, the user is given an opportunity at 28 to tell their friends about the site. From 28 process flow continues with FIG. 3 if the answer is “yes” and continues with FIG. 4 if the answer is “no”.

FIG. 2 illustrates the process flow for adding, deleting, or modifying bookmarks for websites that are in the system database and for which information about the creators (Ys) is known. In FIG. 2 users can upload their current bookmarks from a browser at 37. Bookmarks may also be modified or deleted in 38 and 39, respectively. FIG. 2A illustrates an exemplary screen for accomplishing those functions. As shown in FIG. 2A, categorization recommendations can be made when the bookmark is uploaded, so that the categorization of the bookmark is standardized. If the data entry test performed in 40 and 41 are valid, the quality scores of the bookmarks are calculated at 42. The quality score is initiated at the default value when each page is first entered into the system. It is updated only when user(s) take an action of confirming the quality of the page. Updates can be positive or negative. Modified bookmarks (e.g. main folder/sub folder changes) do not affect bookmark scores. Deletions will remove bookmark scores. After calculation at 42, the bookmark scores are saved in a database at 44.

This database may be updated each time a member adds a page into their bookmark. If this page is already in the database, the bookmark creator's identity and personal characteristics can be added into the record of the page, and the quality score of the bookmarked webpage correspondingly updated. Regular maintenance checks of the database to insure the validity of all the records may also be performed. In summary, information for each page (site) may include quality score (B) (determined by the number of positive and negative confirmations) and bookmark creators (Y).

FIG. 3 is a flow chart of a characterization module for determining a network of friends. The process of FIG. 3 is implemented whenever a current user indicates that they want to tell a friend from decision block 28 in FIG. 1 or FIG. 2. If the friend is already in the network as determined at 48, a message that the friend already exists is displayed at 50 and process flow continues with FIG. 4. If the friend does not already exist in the network, the user can send out an invitation for the friend to join at 52 of the type illustrated in FIG. 3A. Thereafter, process flow continues with FIG. 4. This module is not used to determine relevance or quality of a data point/website. Rather, it is a marketing tool to increase the number of bookmarked data points/websites, which will improve scalability and minimize accidental “bad” searches.

In FIG. 4, an exemplary screen for conducting a search is illustrated. To incorporate conditional searches, the traditional user interface has been redesigned to incorporate the use of multiple input boxes. The use of one input box places undue pressure on the search engine to “read the mind” of the user. The use of multiple input boxes permits weighting of the match of keywords related to the search subject differently from the search purpose. The search query is weighted w(subject)>w(purpose), where it is assumed that search subject is the most relevant factor for searching data. The implementation of multiple search boxes can be accomplished by assigning the keywords in the search subject greater weight than the keywords in the search purpose. This is a new idea, as opposed to current keyword searches where keywords are treated equally and/or in the order typed-in.

FIG. 4A is another example of an input/output screen. The input portion of the screen is similar to the screen discussed in conjunction with FIG. 4. The output portion will have the results of the search. Each result can be viewed and then rated by the user. The “rating” of the results can be used to refine later searches as will be described below.

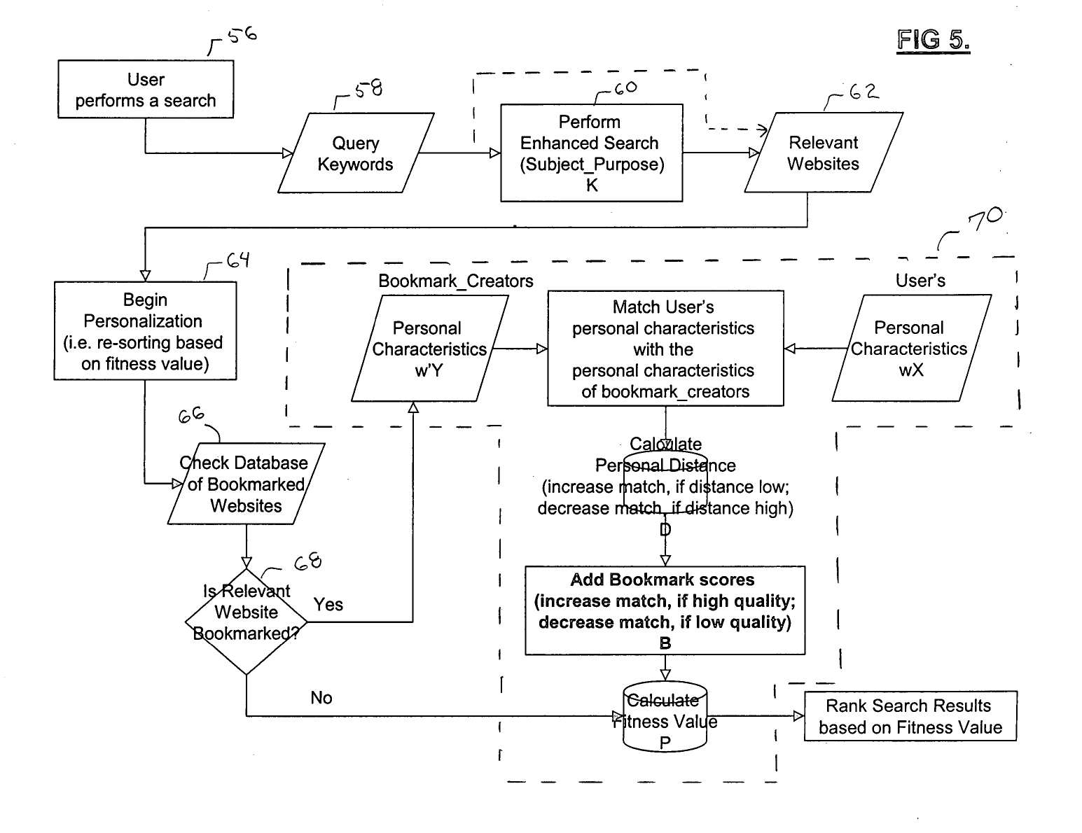

In FIG. 5 the user performs a search at 56 by entering key words. The search engine queries the key words at 58 and a traditional search may be performed and the results displayed at 62. However, if the search terms are entered using a screen of the type shown in FIG. 4 or FIG. 4A, then an enhanced Subject—Purpose search using the weighting discussed above may be performed at 60. The results are again shown at 62.

At 64, the process of re-sorting the search results on the basis of fitness values for each search result (site) begins. The database of bookmarked websites is checked at 66 and a determination made at 68 if any of the sites uncovered as a result of the search are in the database. If the answer is “yes”, then a fitness value is calculated for each such site as shown by the dotted box labeled 70.

The computation engine of the present disclosure calculates a fitness value for each data point in the search based on the query_issuer's personal characteristics (wX), bookmark_creators' personal characteristics (w′Y), and quality (B) of the data point/webpage). The Fitness value (P) of a data point/website can be written as P=function of (D and B), where:
D, personal distance, is a measurement between the personal characteristics of query_issuer (who is a characterized user) and the personal characteristics of all characterized users who have included this page as a bookmark.
D=[Query_issuer(w₁X₁,w₂X₂, wₙX₁)−Bookmark_creators(w′₁Y₁,w′₂,Y₂, w′ₙYₙ)].
Xₙ=Personal Characteristics of User
Yₙ Personal Characteristics of Bookmark_creators
wₙ, w′ₙ=weight of personal characteristics in relation to all personal characteristics,
where, w₁+w₂+ . . . +wₙ=1 and w′₁+w′₂= . . . =w′ₙ=1
Bₙ=Bookmarked data point/websites (quality rating)

For example, query_issuer has a personal characteristic, health=“95” (very health conscious individual, which was determined from the profile questions). If box 68 in FIG. 5 is true, the bookmarks are tested to determine if the bookmark_creators similarly have high health scores. If the health scores are similarly high, personal distance is low and the bookmarks will be given a higher fitness value. This process is repeated for the other personal characteristics (e.g. age, location, etc). For subjective personal characteristics, like job function, there are also similarities (e.g. finance/accountants, doctors/dentists).

In addition, the bookmark scores are included to improve the ranking. High quality scores increase the fitness value, while low quality scores decrease the fitness value. Once the fitness value is calculated for each data point/website, the top ranked items can be presented to the query_issuer as shown at 72.

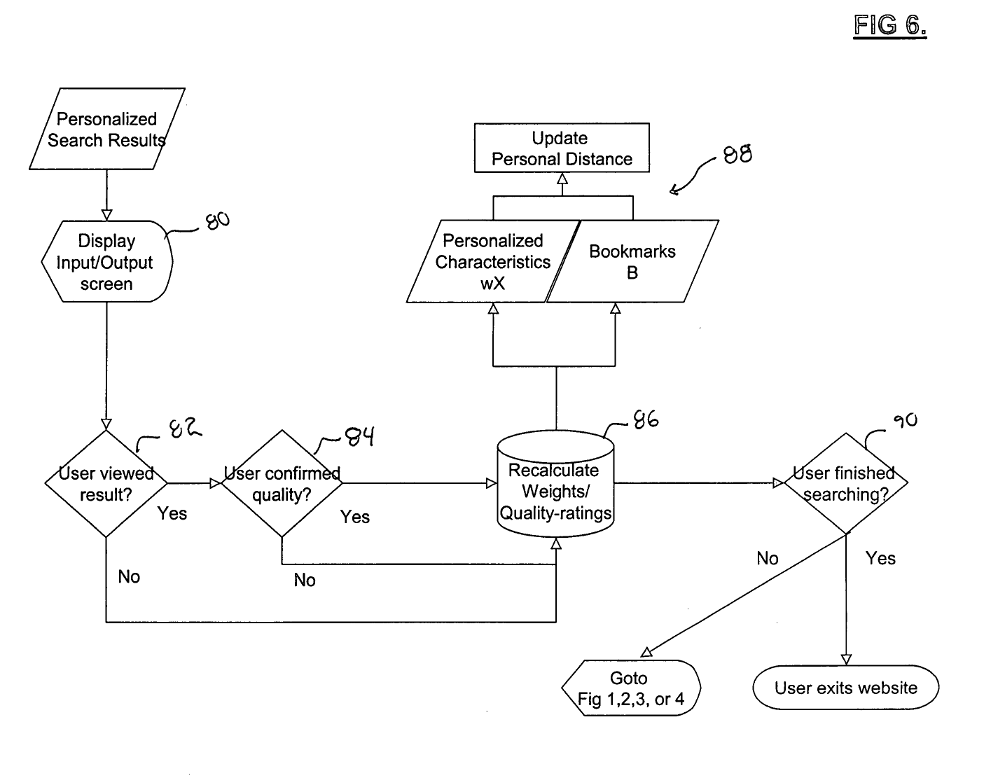

In FIG. 6, the user has the opportunity to explicitly confirm the quality of the search results. This confirmation will trigger an update in the user's profile. Over time, the confirmations will reveal the most dominant personal characteristics. The user's most dominant personal characteristics can be learned and can be weighted more heavily in future searches.

For example, the query_issuer continually confirms the quality of bookmarks that were created by individuals with high health scores. The query_issuer's, w, related to the X for health would increase. Consequently, future searches of the query_issuer would be ranked more towards websites that were bookmarked by health conscious individuals.

In FIG. 6, the results are displayed at 80 using a screen of the type shown in FIG. 4A. If the user viewed a result as determined by 82, and confirmed the quality of that result as determined at 84, then the weights/quality ratings are recalculated at 86 and used to update the personal distance D as shown by 88. When the user is finished searching as determined at 90, the user may exit or may return to any of FIGS. 1, 2, 3, or 4.

In terms of technology requirements, we are using the following: Language C++, Python Script, Web Browser IE 5.0 or higher, 3.0 Ghz Processor (per user), 1 GB Base Memory (per user), Avg Capacity 2.5 MB HTML (per website), and Avg Speed 100 queries/min (host website). We can expand the website's speed and capacity, if necessary.

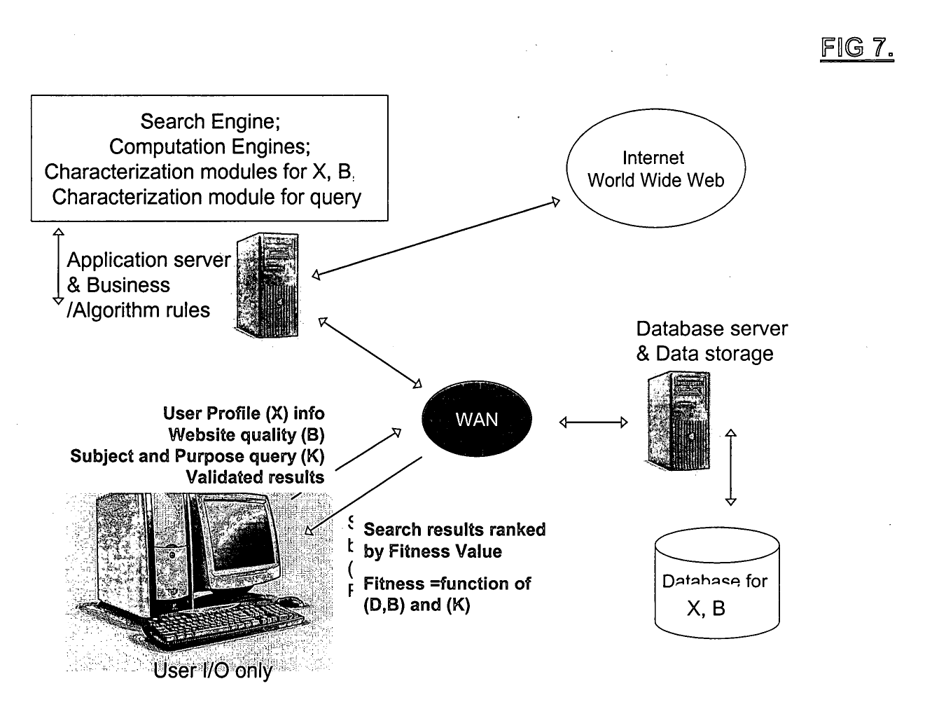

FIG. 7 illustrates an exemplary system for practicing the invention. In FIG. 7, a user may access a search engine and the computation engine via a wide area network from a personal computer or other access point. When a search is requested, the search engine performs the search on the web and returns the results which are re-sorted by the computation engine for display to the user on the users PC. The databases (containing the information about the characterized users, the bookmarks, and bookmark scores) and database server may be separate from the application server as shown in FIG. 7.

We provide premium search results. In our system, users will receive multiple benefits:
Confirmed relevance—Matched search with their personal identity (e.g. a finance professor puts an educational website into his bookmark which will help us recommend it to people with similar finance backgrounds).
Confirmed quality—Matched search with items that have been classified as valuable information (e.g. user bookmarks a website because he wants to return to the website at a later point in time)
Continuous learning—Reconfirmed/refined profile with each additional search (e.g. a person who likes programming will bookmark many sites related to programming, and will receive subsequent searches weighted more towards programming)
Bookmarked statistics to help in analyzing search history
A track-able personal reservoir of revisitable websites
Categorized browsing by identity of creators (bookmarks of finance professors, etc)
Categorized browsing of bookmarks by topic
Contribution into a bookmark network database

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

What is claimed is:

1. A method for characterizing a user, comprising:
obtaining a user's personal information and making inferences based on said information about personal characteristics; and
obtaining bookmarks from the user.

2. The method of claim 1 wherein said obtaining said personal information includes displaying a list of questions for the user to answer.

3. The method of claim 1 wherein said obtaining bookmarks includes selecting a browser and uploading bookmarks saved in said browser.

4. The method of claim 1 additionally comprising assigning a score to each bookmark.

5. The method of claim 4 wherein said bookmark score is originally assigned a default value, and wherein said default value is increased or decreased based upon feedback from the user.

6. A method for ordering websites selected from a database for a characterized query_issuer in response to a serach request, comprising:
calculating a fitness value for each website in the database based on the personal characteristics of the query_issuer and bookmark_creators; and
ranking the search results based on said fitness value.

7. The method of claim 6 wherein said fitness value (P) is a function of a personal distance (D) and one or more bookmark scores (Bs).

8. The method of claim 7 wherein said calculating includes calculating:
D=[Query_issuer(w₁X₁,w₂X₂, wₙXₙ)−Bookmark_creators(w′₁Y₁,w′₂Y₂,w′ₙYₙ)]
Where D=Personal distance
X=personal characteristics of query_issuer
Y=personal characteristics of bookmark_creator
wₙ, w′ₙ=weight of personal characteristics in relation to all personal characteristics, where, w₁+w₂+ . . . +wₙ=1 and w′₁+w′₂= . . . =w′ₙ=1

9. The method of claim 7 wherein said bookmark scores are orginally assigned a delfaut value, and wherein said scores are increased or decreased based on explicit quality confirmations from said query_issuer;

10. The method of claim 7 additionally comprising recalculating the weights on said fitness value based on the user's confirmation.

11. A method for classifying keywords of a search into subcategories, comprising:
obtaining a search subject;
obtaining a search purpose;
assigning a weight to subject keywords and to said purpose keywords.

12. The method of claim 111 wherein said assigning includes assigning weights such that w(subject)>w(purpose)

13. A memory device containing a set of instructions which, when executed perform a method for characterizing a user, comprising:
obtaining a user's personal information and making inferences based on said information about personal characteristics; and
obtaining bookmarks from the user.

14. The device of claim 13 wherein said obtaining said personal information includes displaying a list of questions for the user to answer.

15. The device of claim 13 wherein said obtaining bookmarks includes selecting a browser and uploading bookmarks saved in said browser.

16. The device of claim 13 additionally comprising assigning a score to each bookmark.

17. The device of claim 16 wherein said bookmark score is originally assigned a default value, and wherein said default value is increased or decreased based upon feedback from the user.

18. A memory device containing a set of instructions which, when executed perform a method for ordering websites selected from a database for a characterized query_issuer in response to a serach request, comprising:
calculating a fitness value for each website in the database based on the personal characteristics of the query_issuer and bookmark_creators; and
ranking the search results based on said fitness value.

19. The device of claim 18 wherein said fitness value (P) is a function of a personal distance (D) and one or more bookmark scores (Bs).

20. The device of claim 19 wherein said calculating includes calculating:
D=[Query_issuer(w₁X₁,w₂X₂, wₙXₙ)−Bookmark_creators(w′₁Y₁,w′₂Y₂,w′ₙYₙ)]
Where D=Personal distance
X=personal characteristics of query_issuer
Y=personal characteristics of bookmark_creator
wₙ, w′ₙ=weight of personal characteristics in relation to all personal characteristics, where, w₁+w₂+ . . . +wₙ=1 and w′₁+w′₂= . . . =w′ₙ=1

21. The device of claim 19 wherein said bookmark scores are orginally assigned a delfaut value, and wherein said scores are increased or decreased based on explicit quality confirmations from said query_issuer;

22. The device of claim 19 additionally comprising recalculating the weights on said fitness value based on the user's confirmation.

23. A memory device containing a set of instructions which, when executed perform a method for classifying keywords of a search into subcategories, comprising:
obtaining a search subject;
obtaining a search purpose;
assigning a weight to subject keywords and to said purpose keywords.

24. The device of claim 23 wherein said assigning includes assigning weights such that w(subject)>w(purpose)
